(19) United States
(12) Patent Application Publication
(10) Pub. No.: US 2006/0184454 A1
(43) Pub. Date: Aug. 17, 2006

(54) System and method for copy monitoring and automated invoicing

(76) Inventor: Mohan Ananda, Westlake Village, CA (US)

Correspondence Address: THE HECKER LAW GROUP, 1925 CENTURY PARK EAST, SUITE 2300, LOS ANGELES, CA, 90067, US

(21) Appl. No.: 11/341,193

(22) Filed: Jan. 27, 2006

Related U.S. Application Data
(60) Provisional application No. 60/652,530, filed on Feb. 11, 2005.

(51) Int. Cl. G06Q 99/00

(52) U.S. Cl. 705/57

(57) ABSTRACT

A method and apparatus for monitoring and identifying users responsible for copying copyrighted material, such as digital content provided on compact disks (CD) and digital video disks (DVD), are described. A multi-module software apparatus monitors and detects copying on a network, collects user information, and invoices the user. The system executes the software modules on nodes strategically placed in networks to analyze traffic and detect copying. When copying is detected, the system utilizes a proxy-program, which the system implants in a client machine, to collect user information and transmit the information to a host that allows for invoicing the user. The system utilizes one or more intrusion methods to detect opportunities for the system to implant the user information collection modules.

### CROSS-REFERENCE TO RELATED APPLICATIONS

This application claims the benefit of U.S. Provisional Application No. 60/652,530, filed Feb. 11, 2005, the specification of which is hereby incorporated by reference in its entirety.

### FIELD OF THE INVENTION

The invention relates to computer software, specifically, to a method and apparatus for monitoring and detecting the transfer of a media work over a network, identifying users responsible for the transfer, and invoicing the user.

A portion of the disclosure of this patent document contains material that is subject to copyright protection. The copyright owner has no objection to the facsimile reproduction by anyone of the patent document or the patent disclosure, as it appears in the Patent and Trademark Office file or records, but otherwise reserves all copyright rights whatsoever.

### BACKGROUND

In recent years, unauthorized copying of multimedia through the use of file sharing has created a major economic crisis in the record industry, and record sales have significantly decreased during this period. Contributors to the problem of unauthorized copying include web platforms, such as Napster® and Kazaa, which facilitate peer-to-peer (P2P) multimedia file copying over the Internet.

To fight the P2P copying phenomenon, the record industry has sought the help of the judicial system to protect its copyright interests. The results are not always completely in favor of the record industry. For example, the judicial process led to the stopping of companies such as Napster from facilitating copying of the copyrighted material. However, due to technical differences in the process of content sharing, companies such as Kazaa continued to exist.

Kazaa utilizes a direct user to user exchange for copying, thus circumventing the liability associated with directly hosting copyrighted material at any time. In the Kazaa case, the courts relied on the landmark ruling by the United States Supreme Court in 1984 with regard to the Betamax case (Sony vs. Universal), which held that a manufacturer could not be held for contributory liability in cases where the manufacturer knows that the product may be used for illegitimate purposes, if the product is capable of substantial non-infringing uses. However, the courts in Kazaa recognized that the individual copying the copyrighted data is clearly infringing on the copyright holder's interests and the owner of the copyright may have a cause of action against such individuals. The law in the area of copyright protection is still evolving and more legal proceedings will continue until clear guidelines are provided.

The file-sharing service technology and business models will continue to evolve in a manner that will circumvent legal rulings. Therefore, there is a need for alternative methods of protecting multimedia work interests, either by preventing the copying of copyrighted materials or by enforcing copyright rules. Existing technologies fail to enforce copyright rules to preserve copyright ownership. As a result, copyright owners lose control of the distribution of their works, and possible licensing revenues are lost. Even where unauthorized copiers are discovered, media companies must spend large amounts in legal fees to obtain copyright damages. Particularly with respect to individual copyright violators, the legal system is an expensive and relatively ineffective way to stop copyright violations and/or obtain payment for the use of copyrighted material.

### SUMMARY

The present invention provides a system capable of monitoring and identifying users responsible for copying copyrighted material, such as digital content provided on compact disks (CDs) and digital video disks (DVDs). Currently, users utilize peer-to-peer file copying software and may rely on a connecting platform over the Internet to download digital content. Embodiments of the invention may monitor and detect copying, collect user information and properly invoice users to collect license fees owed on copyrighted material. As a result, media copiers may be transformed into paying licensees, rather than undesirable and possibly unintentional copyright infringers.

In one or more embodiments, the invention may be implemented with multiple software modules, programs or program elements that work in concert. For example, monitoring modules may run on one or more computers strategically connected to networks, or otherwise having access to network traffic, e.g., through proxy-servers. In one embodiment, computers running the monitoring modules may be part of one or more Internet Service Providers.

One or more software modules may be configured to collect preliminary information about the client machine conducting the copying, while other software modules may be configured to implement one or more methods for implanting a computer program in the client machine. Once installed on the client machine, this computer program may collect user information and communicate that information to a host for generation of a license invoice.

Embodiments of the invention may monitor and detect copying of copyrighted material using a multimedia file format that integrates audio/video data, signature data and/or computer program code capable of conducting tasks related to monitoring the transmission of copyrighted materials, such as license validation, encryption and signature verification.

In a typical scenario, a system embodying the invention may collect network data packets and analyze those packets for patterns of data that characterize signature data of copyrighted material. When the system detects the copying of copyrighted material, it may collect information (e.g., the Internet Protocol address, the network domain name, the machine name, etc.) about the receiving machine. The system may then investigate whether the client machine has the necessary rights to copy the material in question. Based on the investigation, the system may determine that the copying is illegal and that action should be taken towards invoicing the user responsible for the copying activity.

In the case where the system determines that a user should be invoiced, the system may implant a computer program and/or signature data into the client machine. The implanted computer program may collect user information for transmission to a host that invoices the user. In one or more embodiments, the signature data may be utilized by the computer program, which may be embedded in the digital content, enabling the program to allow or block the read/write access to the content.

### BRIEF DESCRIPTION OF THE DRAWINGS

FIG. is 1 a block diagram illustrating the concepts of detecting copying, collecting user data and collecting fees in one or more embodiments of the invention.

FIG. 2 is a block diagram illustrating processes and relationships between the processes involved in monitoring and invoicing a copyright infringer in accordance with one or more embodiments of the invention.

FIG. 3 is a flowchart illustrating a process, in accordance with one or more embodiments of the invention, for monitoring network traffic, detecting copying of copyrighted material and invoicing a user responsible for the copying.

FIG. 4 is a block diagram illustrating data and process flow to represent the schema for monitoring data flow in accordance with one or more embodiments of the invention.

FIG. 5 is flow diagram illustrating a process for capturing network data and detecting infringing copying in accordance with one or more embodiments of the invention.

FIG. 6 is a block diagram that illustrates a software architecture for copy-detection, in which components may capture and analyze network data, and identify a user responsible for copying copyrighted data, in accordance with one or more embodiments of the invention.

FIG. 7 is a block diagram representing program components utilized to transplant a data collection program into a client's computer and collect personal information, in accordance with an embodiment of the invention.

FIG. 8 is a block diagram illustrating a network layout in which an embodiment of the invention may carry out copy monitoring.

FIG. 9A shows a typical memory layout of a process running under an operating system as may be used in an embodiment of the invention.

FIG. 9B represents portions of a typical stack region as may be used in an embodiment of the invention.

### DETAILED DESCRIPTION

The invention is a system and method for monitoring copyrighted content transfer, collecting user information of the user responsible of the copying, and invoicing the user with fees owed to the owner of the copyright. In the following description, numerous specific details are set forth to provide a more thorough description of the invention. It will be apparent, however, to one skilled in the art, that the invention may be practiced without these specific details. In other instances, well known features have not been described in detail so as not to obscure the invention.

Terminology

The following description may refer to one or more of media work, multimedia work, content, copyrighted work and other terms commonly used to refer to audio and/or video data. Typically, a media work is printed on, embedded into or embodied within a compact disk (CD) and/or digital videodisk (DVD) for distribution. However, media works may also be stored on other storage media, such as a computer memory (e.g., RAM), a magnetic disk drive, a magnetic tape or any other volatile or non-volatile medium for storing data.

References to a user may refer to a person using a computer application and/or to one or more automatic processes. An automatic process may be any computer program executing locally or remotely that communicates with embodiments of the invention. Processes may be event-triggered upon the occurrence of an action (e.g., establishing a network connection or opening a file). Examples of a user comprise a person using a web browser application to access a system embodying the invention, a script program or any other computer program; the user may be embodied in any of such computer programs acting on behalf of persons to access copyrighted material.

The invention described herein is set forth in terms of methods and system elements. The methods and systems of the invention may be implemented, for example, as computer program code capable of being stored in the memory of a digital computer and executed on a microprocessor, or as a hardware-based implementation (e.g., using digital ICs, field programmable gate arrays (FPGAs), etc.), or as a combination of hardware and software elements.

Throughout the disclosure the terms relating to user interface comprise any type of electronic system capable of receiving and transmitting data, either over a wire or wirelessly. These systems comprise, for example, computers having computer displays, mobile phones, portable devices and the applications executing on these systems. The applications may comprise, for example, computer operating systems, Internet browsers, graphics rendering applications, voice communication applications, and any application capable of presenting data to a user and receiving input from the user.

The term “server” may be used to refer to the hardware acting as a server, or to a computer program running on a computer (or a cluster thereof) to provide the service. A “machine” may refer, for example, to physical hardware, to a virtual machine such as a JAVA Virtual Machine (JVM), or to separate virtual machines running different Operating Systems on the same hardware where they can share the computing resources.

References to client and server connections or network connections do not necessarily involve a physical network such as an Ethernet network. Clients and servers may reside on the same machine, for example, as in the case of a web site running on a supercomputer. In the latter case, web servers (e.g. Apache Web Server) and one or more application servers may be running on the same physical machine, coupled by a virtual network. Embodiments of the invention are capable of running on virtual networks as well.

References to a data source may refer to any means from which a computer may obtain data, e.g. using one or more protocols. Examples of data sources may include flat files residing on a file system, an electronic mail server, a Lightweight Directory Access Protocol (LDAP) based server, a database and any other means capable of serving data. References to a database schema may refer to a data structure/organization that characterizes the data source in question (e.g. Electronic mail server or LDAP server).

In embodiments of the invention, each component may be implemented as a part of a large infrastructure (e.g., within an application server) or as a dynamic link library (DLL), plug-in, applet or other separable component that may be embedded within, or interfaced with third party components or applications.

System and Method Overview

Systems embodying the invention provide means by which a user who copies copyrighted material by utilizing a peer-to-peer file copying software or platform over a network, such as the Internet, can be monitored and identified. Furthermore, the system provides means for automatically invoicing the user upon detecting such copying activity. The system detects the transfer/copying of media work, identifies the target user and monitors the user to detect when media content is being copied without permission from the copyright holder. The system may collect the user's identification data, generate an appropriate invoice to cover the copyright license fees, and contact the user for payment.

FIG. is 1 a block diagram illustrating the concepts of detecting copying, collecting user data and collecting fees in accordance with one or more embodiments of the invention. A system embodying the invention may be configured with one or more processes 130 for monitoring data (e.g., data packets) transferred between a host (content host 115 hosting media work 101) and a client system (destination 120) through a network (e.g., Internet 110). Copy-detection processes monitor user activity during the copying of data from a computer hosting audio/video data. Embodiments may support monitoring of existing and marketed CD or DVD formatted data, as well as new CD or DVD formats, such as those proposed in this disclosure.

In the illustrated embodiment, when processes 130 detect copying of copyrighted content 101 from content host 115, one or more identification processes 140 identify the infringing user at copy destination 120. User identification may involve one or more techniques for investigating the client machine's existing data and identifying personal information (see below for details). Based on the identification of the user, one or more invoicing processes 150 may be configured to collect fees using fee collection instruments in accordance with standard accounting and fee collection procedures.

Media Work Data Format

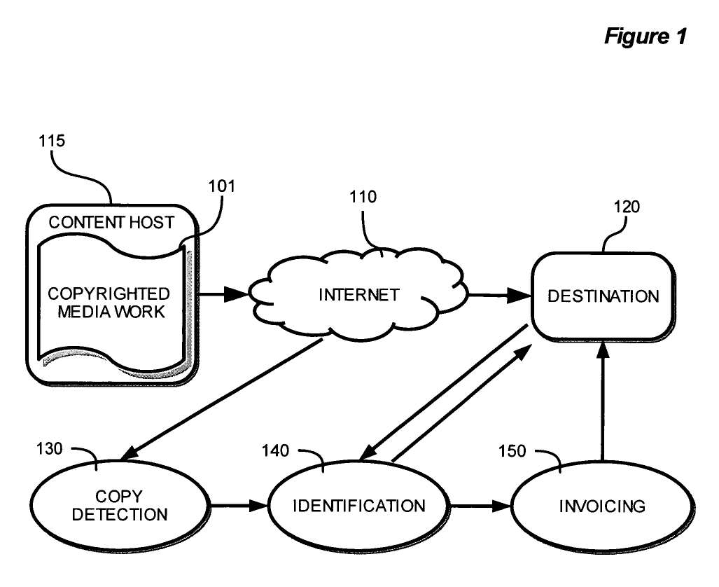

FIG. 2 is a block diagram illustrating a process for monitoring and invoicing a copyright infringer in accordance with one or more embodiments of the invention. In one or more embodiments of the invention, the formatting scheme of the media work contains embedded code and/or data that enable a player (e.g., a media player device or a computer application) to identify the media work and restrict playing the media work unless one or more conditions are satisfied. For example, the embedded code and/or data may form a passive element (e.g., a key) or active element (e.g., a key function) in an encryption/decryption scheme that allows the player to obtain intelligible audio/video data only when the embedded code/data is present and loaded/read by the player.

In a preferred embodiment, the data format is backward compatible, such that players that lack full support for the formatting scheme of the invention are nevertheless capable of playing the media work. In other embodiments of the invention, the formatting scheme may comprise separate file entities that represent the audio/video data and the code data, respectively. The player application is then configured to locate and load the code data based on a known association with the audio/video data, e.g., a set naming convention, relative file location, a reference to the code data file in the header of the audio/video data file, a particular encoding of a portion of the audio/video data that identifies the code data file (e.g., replacing the least significant bit of the first thirty-two audio values with respective bits of a thirty-two bit code identifier/link), etc.

In FIG. 2, block 101 portrays a media work having a header 102 that contains the embedded code and a data portion 103 that contains the audio/video data. In one embodiment, header 102 comprises a header digital record that is added to the data content. To provide backward compatibility, the header digital record may be configured to be neither recognized nor detected by existing audio/video players. When a computer makes a copy of the audio/video content, the computer copies all data, including the header digital record.

The header digital record may be executable code of data capturing software that takes up residence in the computer with the copyrighted data content. The data capturing software creates a data file containing relevant information about the computer and/or user and transmits that information to the monitoring system server. The data file also identifies whether a copy is obtained directly from a CD or DVD or through a peer-to-peer file system over the Internet.

In subsequent steps, if the copy is made directly from a CD or DVD, the monitoring system may be configured to assume that the copy is intended for limited personal use and thus omit sending an invoice to the user. However, if the copy is made through a peer-to-peer file copying system, an invoice may be prepared and sent to the user.

When a first user copies copyrighted data content over the Internet from another user who has obtained the data from a newly formatted CD or DVD, the first user copies the data capture software (header digital record) along with the audio/video data content. This data capture software first checks whether there exists any previous version of the data capture software in the first user's computer, and if it finds one, it updates the software. Then the data capture software creates a data file as in the previous case and transmits the file to the monitoring system server when the first user connects to the Internet.

Monitoring Data Flow Over the Network and Invoicing Users

In FIG. 2, block 230 represent one or more software modules capable of monitoring network traffic and detecting media content transfer over a network from host 210 to client device 120 (e.g., a computer running a browser, a download application or any other application capable of remotely accessing the media work files or data streams on the host). Once a client system 120 accesses host system 210 to copy copyrighted material, the detection process invokes one or more software modules 240 that carry out the processes of: gathering information about user 105 (the copier); matching the copied media data with a library (e.g., a database) of copyright data referencing the respective copyright owner; and invoicing user 105. For example, a software module may notify user 105 of the license fees due through a graphical widget (e.g., by inserting a pop-up window on a computer display, by displaying an icon), an electronic message (e.g., using an instant messaging means or electronic mail, etc.) and/or a paper invoice which further processes in the system may convey to the user through the postal services.

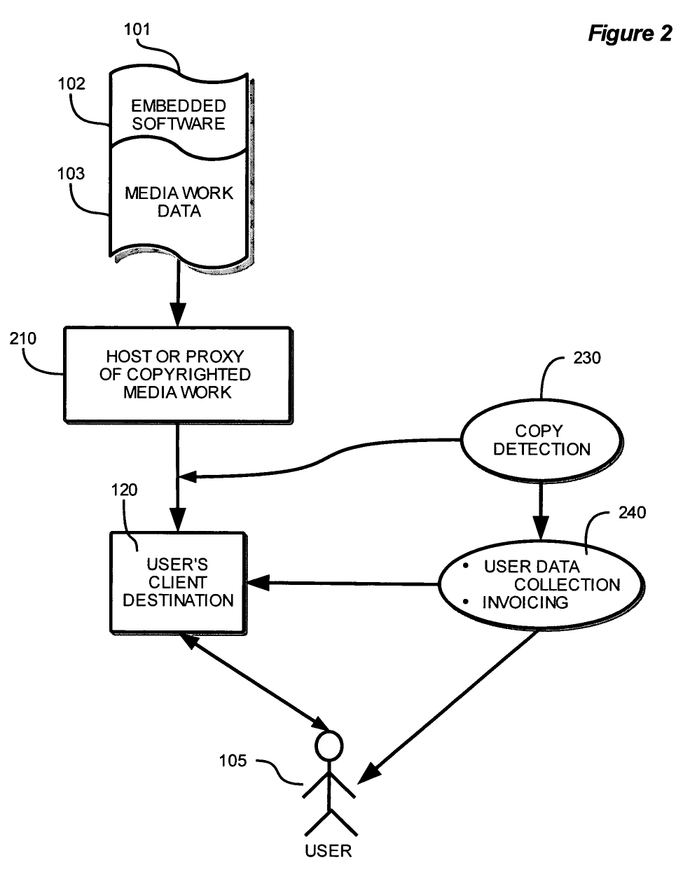

FIG. 3 is a flowchart illustrating a process for monitoring network traffic, detecting copying of copyrighted material and invoicing a user responsible for the copying, in accordance with one or more embodiments of the invention. At step 310, a system embodying the invention continuously executes monitoring programs that allow the system to obtain and investigate network data packets. In other embodiments, the monitoring programs may execute in response to specific events. For example, a monitoring program may be invoked when a client user is accessing specific areas of the network, or when users from a specific domain or Internet area try to access media work on a data storage system.

At step 320, one or more detection programs investigate network packets by checking a plurality of data characteristics of data carried by the packets. For example, the detection programs may check for specific signature data that indicates multimedia work is being transferred. The signature may be part of the header data (described above) and/or signature data based on the execution of program code born by the header.

One or more other programs may be utilized as helper applications to enhance the detection process. For example, data packets may carry compressed and/or encrypted data. In embodiments of the invention, helper applications allow the detection programs to decrypt/encrypt and/or compress/uncompress data in order to allow those detection programs to investigate data packets. Typically, the signature data may be matched against a database of stored signatures that identify copyrighted materials. When a certain level of match is reached between a data signature contained in a packet and one stored in the database, the system invokes, in step 330, one or more programs configured to gather the user's information.

The data gathering modules may execute one or more processes that proceed in one or more ways to collect the data. For example, those processes may identify the user by the Internet Protocol (IP) address of the client machine, and fetch from a database all personal information associated with the IP address. Other processes may utilize user login information that the user may provide to the host system to access the copyrighted material. Embodiments of the invention may utilize any available means for gathering user information.

In one or more embodiments of the invention, one of the processes of the monitoring system is configured to access the user's computer and execute a resource that allows for gathering user data and eventually communicating with the user. For example, the system of the invention may scan network ports on the user's computer, and open one or more network sockets. The system then transfers monitoring software through one of the open network sockets into the user's computer, facilitating data collection on the user's computer.

The monitoring software may also be part of the header schema utilized in the formatting of the multimedia work. For example, when a user executes a media player that loads the media work, the media player also executes program code from the media work header, which allows for gathering data. In the latter case, the monitoring software may send the gathered data to a system embodying the invention for further processing (e.g., invoicing). The monitoring software may also be triggered by the system's transmission of a specific code (e.g., in the form of a cookie) to the client's machine.

The system of the invention creates a transaction log that includes user information, digital content header information that identifies the copied digital content, the number of bytes copied, information regarding the peer from which the copy was made, the date and time of copying and any other relevant information.

At step 340, having collected the user's data at step 330, the system proceeds to invoice the user. One or more processes may be involved in invoicing a user. For example, the embedded code may be enabled to communicate with the user through electronic media means such as utilizing a pop-up window, an instant-messaging (IM) message, an electronic mail invoice message or any other means usable for notifying the user. In one or more embodiments of the invention, the system also generates paper work for an invoice that is transmitted to the user via postal services.

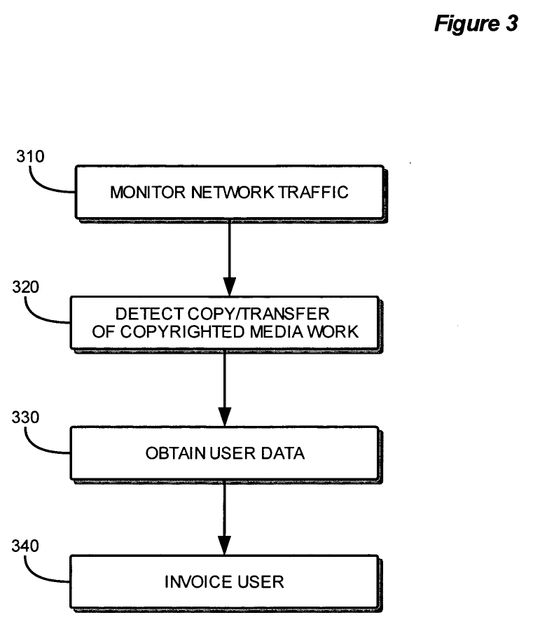

FIG. 4 is a block diagram illustrating data and process flow to represent the schema for monitoring data flow in embodiments of the invention. Block 410 illustrates the network infrastructure that supports the data transmission between sites hosting copyrighted media works and clients accessing those media works to download copies. Block 420 represents the data access infrastructure through which embodiments of the invention capture network packets. The network data capturing software may reside on the host of the media work and/or in proximity to the user.

In a typical deployment strategy, an Internet Service Provider (ISP) installs the system implementing the invention on a proxy server (e.g., a firewall), allowing the system to investigate the data packets destined for client computers within the Internet service provider's domain. The clients may be connected through telephone lines, broadband connection (e.g., Internet cable access services, Digital Subscriber Line services (DSL), Integrated Services Digital Network (ISDN)) or any other connection that the ISP provides for connecting users to the Internet. Access to network packets may be achieved without having access to either the host or the client computers. Examples of existing techniques for capturing network packets include packet “sniffers” utilized in network wire-tapping.

Block 430 represents a network data capture device. A network data capture device may be, for example, a computer attached to the network, that is capable of capturing all network traffic broadcast over the network. In other instances, the data capture is carried out by a software module that is part of a gateway, a router, a switch, a repeater or any network device capable of carrying network packets. For example, a data capture software module may be embodied as part of a firewall that filters the packets, in which case the packets may be passed to (or through) the software module for investigation (see below for details).

Block 440 represents a software module designed to analyze the network data packet. For example, the module may decrypt and/or decompress data contained in the packets, store the packets, index the packets so as to relate packets to each other in the case of large streams of data, and carry out any type of analysis that leads to determining the identity of media work being copied. Module 440 may access database 460 to match a detected media work signature code to an entry in a library of such signatures.

Block 450 represents a process for detecting media work copying. When a user is accessing a media work, he/she may do so in one or more of many scenarios. For example, the user may be the owner of the media work, and be allowed to make multiple copies. The user may also make a copy and preserve the original copy for backup only. Embodiments of the invention may be configured to distinguish between different infringing and authorized scenarios, and produce a result following a multi-level analysis and detection of infringement.

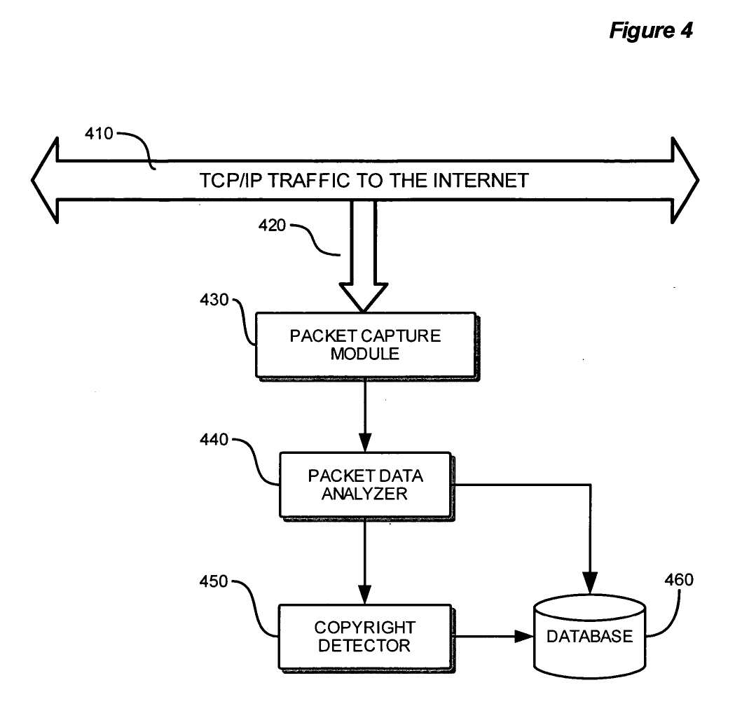

FIG. 5 is flowchart illustrating a process for capturing network data and detecting copyright infringing activities, in accordance with one or more embodiments of the invention. At 510, the system embodying the invention obtains the header information from the content data of a packet as captured by capture module 430. Header information, as mentioned above, may comprise media work information as well as other information identifying a media work and the number of times the media work has been, is or may be reproduced.

At step 520, the system checks the media work signature against a database of signatures. The latter step allows the system to determine whether the copied media work is proprietary and whether it is covered by copyright protection. Furthermore, the system may determine whether the media work is associated with any other licensing rules. For example, the host of a media work may be a vendor who is allowed, under an agreement with the copyright owner, to distribute a certain number of copies for a fee (or for free), in which case the system may ignore the copying, or simply make a log of the copying for accounting purposes.

At step 530, the system determines whether the media work is associated with a signature code. If the media content's signature is not found in the database, the system may ignore the copying (step 535). When a signature code of media content is found in the database, the system logs information about the copying session at step 540. For example, when a user attempts to connect with a web address (where media content is hosted), the system intercepts such contact and captures the Internet Protocol address of the user. In one or more embodiments of the invention, capturing of the user's IP address occurs without the knowledge of the user conducting the copying.

At step 550, the system invokes an identification program that allows the system to match the first collected information with stored (or previously collected user data). Based on the stored information, the system may permit the user to copy a media work a given number of times, as may be the case where a suitable copy agreement exists between the copyright owner and the user or the host. Such agreements may be represented by access and/or invoicing rules stored within the system in association with the corresponding media work signature (e.g., in a relational database).

At 560, the system implants a program (i.e., the monitoring code) into the user's machine to gather user information and transmit that user information to a data store.

Embodiments of the invention utilize a new formatting scheme for the CD and DVD. The latter formatting scheme may be backward compatible such that the newly formatted CD or DVD can be played in all existing audio and/or video players. The new formatting scheme integrates data capturing software similar to that disclosed earlier in connection with the audio/video data content on the CD or DVD. Any copying of any part of the CD or DVD by a user through a computer triggers the simultaneous copying of the data capturing software onto the copy-receiving computer. Where the data capturing code is separate from the media content (e.g., missing in prior CD or DVD data, or embodied as a separate file entity), the network monitoring software sends data capturing software (e.g., like a cookie) to the user's client machine. The data capturing software may be kept resident in the user's computer, tracking media activity and creating a data file that contains all the information pertaining to any copying of audio/video copyrighted content, as well as any personal contact information of the user.

The data file may contain the digital content header information that identifies the copyrighted data content, the number of the bytes copied, the information of the peer from which the copy is made, the date and time of the copying, the information of the platform such the computer application, software version, maker of the application and any other information that may identify the facilitator of the copying transaction. The data file may also contain all the personal information of the user, such as electronic mail addresses, postal addresses and any other personal information that is stored in the user's computer.

The data file gathered by the program may be automatically transmitted to a system server (e.g., on a periodic basis and/or upon an update event) while the user is connected to the Internet. Furthermore, when a new user copies the audio or video copyrighted data content utilizing a peer-to-peer file copying software or platform over the Internet from the original user's computer, the new user also automatically and simultaneously copies the data capturing software to the new user's computer.

Copy Detection Module

Embodiments of the invention implement one or more software modules for detecting media content transmitted over a network. The detection software may be executed on a part of the network where it has access to network traffic for capture and examination of data. For example, the copy detection software may be executed on network gateways (e.g., network traffic routers, firewalls or any other device handling network traffic) of one or more Internet Service Providers (ISPs). Alternatively, the software may be executed on any node of the network, e.g., on a dedicated server, or as part of a service on a shared server.

To detect the copying of media material, the detector continuously and actively monitors network packets. When the detection module sees that copyrighted content is being transmitted, it initiates identification of the copier through an identification module.

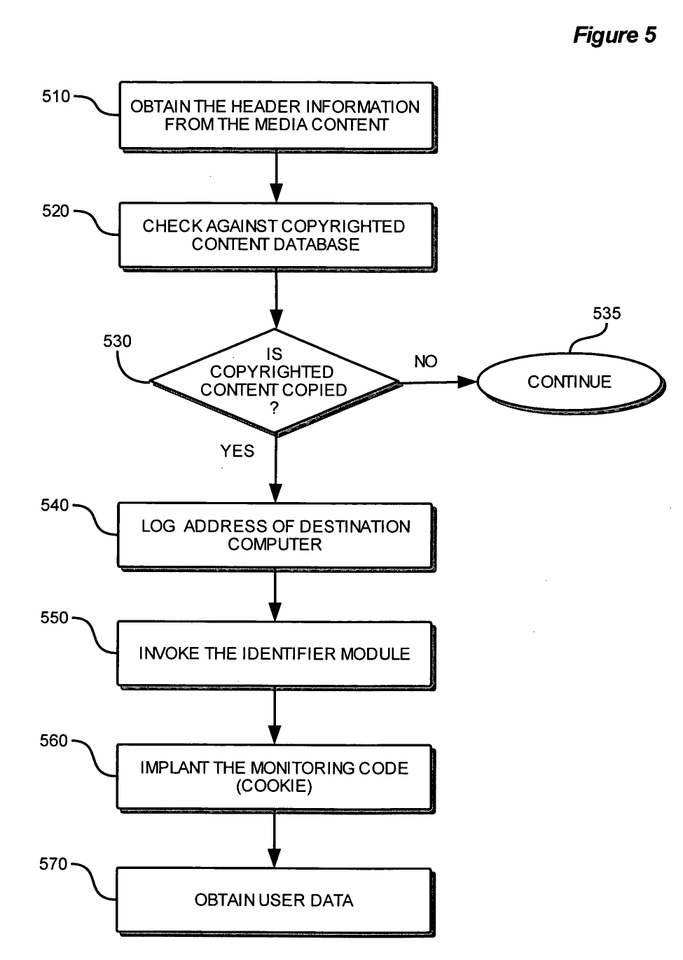

FIG. 6 is a block diagram that illustrates the architecture of the copy detection software in which components capture and analyze network data, and identify a user responsible for copying copyrighted data, in accordance with embodiments of the invention. Block 600 represents the software module, which may be implemented as a single computer program executing on a single machine or as a distributed application executing on multiple servers. Block 610 represents components configured to detect and capture network data (e.g., packet “sniffers”).

Packet sniffing is a process by which a program may utilize a connection to the network to capture network traffic, including data not destined for the node on which the application is running. Typically, network packets (e.g., using the combination of Transport Control Protocol (TCP) and Internet Protocol (IP)) hold the destination Internet address (and eventually the hardware MAC address) for which the packet is destined. The Internet Protocol of a node determines, based on the latter information, whether that node should handle the network packet. When the packet holds a destination address that matches the local address, the network software of the node invokes the proper service to handle the data packet. Otherwise, the packet is ignored because a different node (e.g., another machine on the network or a different network interface) is expected to handle the network packet. Packet sniffers capture network packets regardless of their destination.

In one or more embodiments of the invention, once packet sniffing module 610 captures a data packet, another module 620 carries out the process of analyzing the packet. Packet analysis for the purposes of the present invention involves extracting information from the packet that relates to copyrighted data. Module 620 matches the information from the packet against copyrighted media information stored in a database of copyrighted content data 640. This database may contain relevant information with regard to the content under scrutiny, such as header information that uniquely identifies the content for each media file.

Module 610 collects information from the data packet and stores the collected data in a copy database 650. This database may serve as the system of record for all attempted copy incidents, and may be utilized by different modules in the system. The copy detection module records, for example, information such as client Internet protocol (IP) address, whereas other modules may collect and store other details in database 650. The database may also serve to keep track of transactions and payment status. Table 1 is an example of data fields the database may maintain with regard to copying of copyrighted material.

TABLE 1

| Field Name | Description |
|---|---|
| Copier IP | IP address of the copier's computer. |
| Server IP | IP address of the sender. |
| Copier Computer Name | The name of the user's computer, as |
| | locally referenced and/or resolved by |
| | a domain name server (DNS) |
| Name | User's name |
| Address | User's address |
| Email address | User's Electronic mail address |
| Billing Address | User's billing address |
| Time stamps | Copy time stamp |
| Content identifier | Unique identifier indicating the content |
| | that was copied. |
| Bill sent date | Billing log of sent bills (e.g., time of |
| | day, month, day, year) |
| Payment status. | Status of payment (e.g., received, |
| | outstanding, deferred, canceled) |

Database 650 may be utilized to store the number of attempts made to copy the media material and any other information available that may be subsequently utilized to identify and monitor the user responsible for the copying.

Block 630 represents the software components involved in identifying the user responsible for infringing copyright of media works. In addition, component 630 may trigger one or more processes leading to the extraction of the user's personal information for billing purposes.

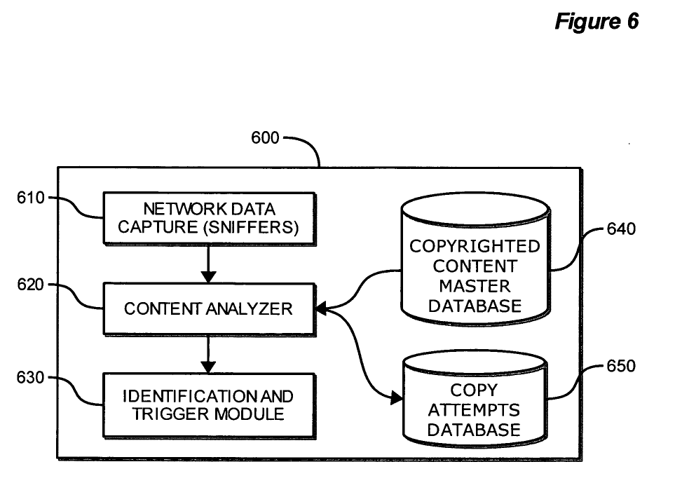

FIG. 7 is a block diagram illustrating program components utilized to transplant a data collection program into a client's computer for collecting personal information, in accordance with an embodiment of the invention. Block 700 represents software components that may be utilized to embed a program in a client's computer in order to collect user information and communicate it back to a host for monitoring copying activity and billing the user for the copying. Software 700 may be executed on a single a machine or on multiple servers configured to execute on any number of nodes and networks.

Block 710 represents program components involved in extracting and storing information received from client computers. Block 720 represents the process trigged when the copying of copyrighted material is detected. Process 720 may employ a variety of methods to place a program in the client computer to extract information and transfer that information back to the monitoring and invoicing system. In some embodiments, the extraction program is voluntarily loaded by the user either knowingly or unknowingly (e.g., as an undisclosed element of another loaded application).

In one embodiment of the invention, the extraction functionality may be integrated within a file loading program that the user installs on the client computer to handle all media purchases conducted on the network. For example, the user may access a music download and choose to have all billing matters automatically handled by the extraction software without having to input user information, billing information or any other type of information required for billing purposes. Similarly, the extraction functionality may be loaded on the client system as part of a media player application.

The user may not elect to purposefully install an application that includes copy detection functionality. In this case, one or more embodiments of the invention utilize one or more intrusion techniques to benignly implant a program into the client machine to collect user information and communicate that information to the system for billing. Examples of such intrusion techniques are further detailed below.

Block 740 represents the set of components implemented on the machine acting as the recipient of copyrighted material. Once an embodiment of the invention has implanted a program for extracting and collecting user data, that program executes locally, in the background, and may gather any type of user information that may enable identification of the user for subsequent billing.

Block 750 represents data files that gather all collected information. Block 760 represents a data set (e.g., an electronic “cookie”) that may bear any type of information enabling the data collection program to function properly. For example, the cookie may store information provided by the system in order to identify the material being copied, and/or the system may store in the cookie an encryption key or function to enable secure data transfer. The cookie may also store key information (e.g., a signature) that helps the program authenticate itself and not compromise the user's data.

Embodiments of the invention may utilize a number of data sources on a typical computer to find and collect user information. For example, the operating system's registry typically holds information related to the owner of the computer (e.g., license information of a Windows(TM) operating system's registry), which includes the user name, email address, address and any other information available. Also, many applications store user information (e.g., license information) in one or more configuration files from which embodiments of the invention may obtain available user information.

Block 770 represents a program component for handling data transfer between a client computer and a billing system. Once the data is collected, data exchange processes 770 communicate with information collection processes 730 to transfer the user's information. Processes 770 may be configured with a variety of data collection methods to collect user information. For example, processes 770 may display a message to the user, and eventually prompt the user through a user interface to enter billing information. The program may propose, for example, special promotions to the user such as enrolling the user in a music club or any other means to facilitate the user's contribution to the copyright holder.

The implanted program then communicates back with a server running an embodiment of the invention. For example, once the information is collected, the program may attempt to open a network connection (e.g., a hyper-text transport protocol (http) connection) and post the data to a copy monitoring or billing server (e.g., a web service). The server then stores all the submitted information to a database for further actions, including billing.

Methodology for Implanting Data Collection Program

A system embodying the invention may implant a program into the client machine utilizing one or more methods for transferring and executing computer programs on the client machine. A system may stuff data into the network packets as they are sniffed from the network. In the latter case, the system captures packets destined for the recipient's computer, then generates packets that hold replacement data. As described above, the media data may be implemented using a new format that may have a header and/or an attachment capable of holding data and computer instructions. The computer instructions may execute and support the data collection mechanism described above.

In one or more embodiments of the invention, the system may check for vulnerabilities that allow an outside system (e.g., a copy-detection system) to implant executable programs on a client's computer. For example, the copy monitoring server may check for an open network port (e.g., port 21, associated with file transfer protocol, FTP) on the client's computer and open a network socket through which the copy monitoring server may transfer the collection program data. In other instances, the system may push the client's system towards committing the error of opening network sockets. The latter may be achieved by overloading certain services with network traffic.

The monitoring system may also commandeer a connection between a client and a host. The monitoring system may send a spoofed packet (i.e., a packet falsely identifying the client as the packet source) to the host system to request a “close connection,” while posing in place of the host system with regard to traffic with the client's machine. The monitoring system can then send a data collection program to the client.

IP spoofing involves forging a host's IP address as a source address, using one machine to impersonate another. Many applications and tools in UNIX systems rely on source IP address authentication. Where IP spoofing is not sufficient, ARP spoofing may be implemented. ARP spoofing involves forging a packet source hardware address (MAC address) of the host being spoofed. A simple active attack against TCP connections may be implemented in which the attacker does not merely read packets, but takes action to change, delete, reroute, add or divert data. Perhaps the best-known active attack is “Man-in-the-Middle”.

A system embodying the invention may exploit the variations in the implementation of the Transmission Control Protocol/Internet Protocol (TCP/IP) in different environments. For example, the monitoring system can use “IP spoofing” to send a cookie to the client system, with the cookie labeled as if the cookie came from the source computer. For example, using a “man in the middle” attack (sometimes referred to as “TCP hijacking”), the monitoring server may sniff packets from the network, modify those packets, and put them back into the network. Examples of programs/source codes that can accomplish a TCP hijack include Juggernaut, TSight and Hunt. TCP hijacking is an exploit that targets TCP-based applications like Telnet, rlogin, ftp, mail applications, web browsers, etc.

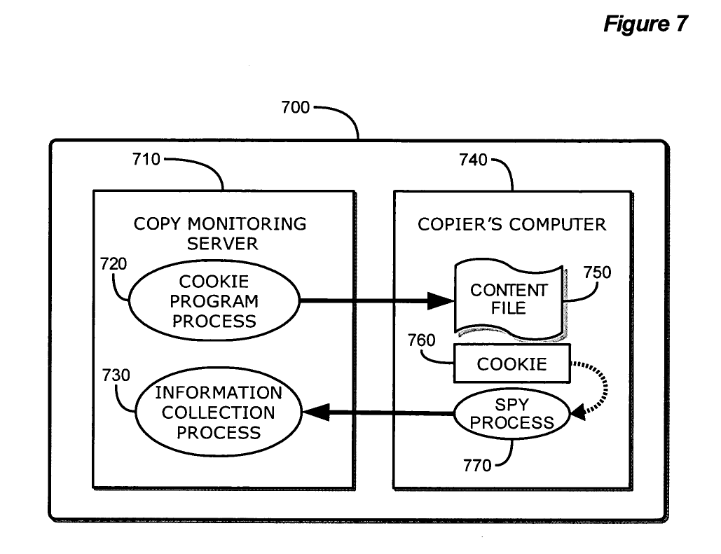

FIG. 8 is a block diagram illustrating a network layout in which an embodiment of the invention may carry out copy monitoring. In the illustrated scenario, the copy monitoring server is represented by block 810; the copying system is represented by block 820, and the downloading source/server is represented by block 815. Copying system 820 is the system used by the copier for Telnet client connections to the target system. Target 815 is the target system where server programs (e.g., file transfer protocol-based server program) run to serve content.

The copy monitoring server 810, copier system 810, and target 815 are connected through a network of nodes (e.g., routers 830 and 840) and a backbone network support 850. The diagram of FIG. 8 shows the copy monitor and copier hosts are on the same network (which can be Ethernet switched and the attack will still work), while the target system can be anywhere on the network. In other instances either copier or target may be on the same network.

In embodiments of the invention, the copy monitoring system attempts to send a cookie, by exploiting one or more system vulnerabilities of the copier's computer, once the copier's IP address has been determined by the copy detection module. Typically, the latter is accomplished by exploiting some of the networking components or server daemons that may be running on the computer.

Activating the Data Collection Program

As in the case of sending the data collection program to the copier's computer, a system embodying the invention may exploit system vulnerabilities to activate a data collection program. The latter is achieved in a manner that may be similar to a virus or Trojan horse program activation. The following is a description of two potential methods for activating the identifier module in the copier's computer.

A system embodying the invention may exploit scripting vulnerabilities in the client computer's applications. Scripting is widely employed and supported by applications such as WEB browsers, media players and macro execution engines. The latter applications enhance the user's computer usage experience. Media players, such as the one available from Microsoft, are now available on many operating systems (OS). These media players are enabled to execute scripts that are included within media files. However, scripting also opens up potential opportunities for entry into the computer. Thus, the system embodying the invention may implant the cookie as an embedded script in the media content. Once the user tries to play the downloaded media file, the cookie may be activated.

Embodiments of the invention may expose and exploit other vulnerabilities in a client's machine. For example, embodiments of the invention may expose and exploit a typical vulnerability called buffer overflow. The latter vulnerability is due to insufficient test of computer memory boundaries while executing computer programs. When the program code does not sufficiently test for the location of memory where data is written, it may allow an attacker to overwrite data in critical memory locations, which in turns allows the attacker to write more data into the memory and execute newly implanted code.

The following program code, Program code 1, is an example of program code written in the “C” language showing the usage of a buffer:

Program Code 1

```
int main ( ) {
  /* declare a buffer for 50 characters */
  int buff[50];
  /* Try to access the 100^{th} character as follows.
  buff[100] = 10;
}
```

A buffer is typically a contiguous allocated block of memory such as the array named “buff” in Program Code 1. A buffer is typically accessed through a memory location address (e.g., pointer to memory location buff[10]). Program code 1 is syntactically accurate, but it may yield unexpected behavior when it attempts to write to a memory location that is beyond the allocated memory for the buffer (e.g., access to buff[100] when the size is only 50). Overflow vulnerability exists in programs that do not properly check for buffer boundaries.

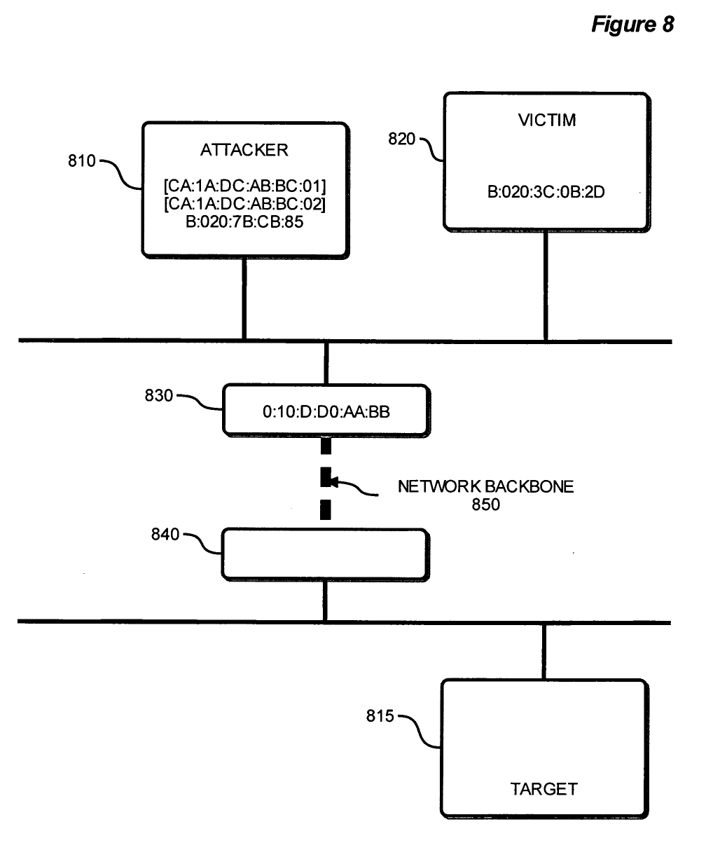

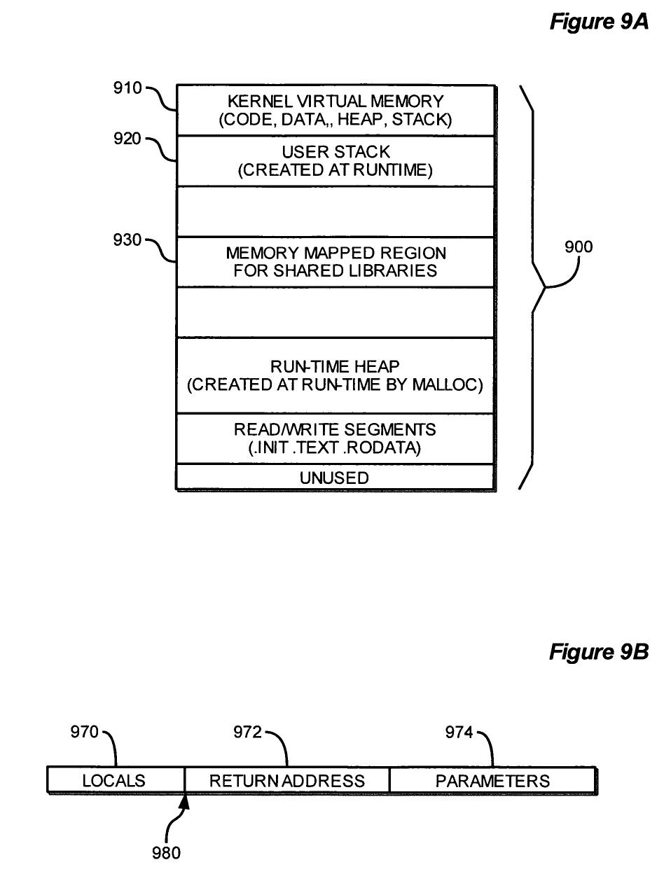

FIG. 9A shows a typical memory layout of a process running under an operating system as used in an embodiment of the invention. A process instance, also called a task, is a copy of a program that the kernel loads into the memory (e.g., block 900) for execution. During the loading, a memory area is reserved for the process, which allows the process to initialize memory locations used for program instructions and global data (e.g., block 910). Global data may be accessed from anywhere in the program. The latter is in opposition to memory that is allocated at run-time and used for a limited time. For example, an application that loads files from a disk may allocate (through a request to the kernel) a memory location (or a buffer) each time there is a need to load data into the memory.

A process also requires allocating and initializing memory for the process to work with other programs. For example, the process may utilize one or more codes from one or more libraries. In the latter case, the code from the libraries may be loaded elsewhere in the memory, but the pointers to resources in the libraries are stored and initialized in a portion of memory (e.g., block 930) associated with the process memory 900.

The Stack is a contiguous block of memory containing data (e.g., block 920). A stack pointer points to the top of the stack. Whenever a function call is made, the function parameters are pushed onto the stack. Then the return address (address to be executed after the function returns), followed by a frame pointer, is pushed onto the stack. A frame pointer is used to reference the local variables and the function parameters, since these are typically located at a constant memory distance from the frame pointer. Local automatic variables are pushed after the frame pointer. In most implementations, stacks grow from higher memory addresses to the lower ones.

FIG. 9B represents portions of a typical stack region as used in an embodiment of the invention. The stack shows portions of memory reserved for storing data used by a function (e.g., block 970), a portion for storing function parameters which typically include the return address and function input arguments (e.g., block 972), and a portion of memory that stores the argument (or parameter values) represented by block 974. The frame pointer is typically stored at the beginning of the function return address portion (e.g., location 980).

In a typical buffer overflow attack technique, the attacker writes data into a buffer zone. Loading the vulnerable program with data that exceeds the buffer size. The data may eventually contain program instructions which over-write the memory including the return address portion. As the program returns to the return address for execution, it may be re-routed to execute the newly implanted instruction into the memory, or to execute another program in the memory. Examples of the latter program may include operating system helper applications for changing user accounts, changing file ownerships, authentication methods, changing properties of network services running on the server and any other application that may be affected.

Embodiments of the invention may utilize the method of buffer overflow to gain access to the system resources and install a data collection program capable of collecting user information and communicating the information to a server configured to track the user's copying of the copyrighted material and invoice the user for such copying.

Thus, a method and apparatus for monitoring the copying of copyrighted material and invoicing the copier have been described. The following claims define the metes and bounds of the invention.

The claimed invention is:

1. A method for enforcing copyright comprising:
monitoring a copying transaction of a copyrighted material;
assessing whether a user involved in said copying possesses a right to copy said copyrighted material;
collecting a set of identity information of said user; and
invoicing said user.

2. The method of claim 1, wherein said monitoring further comprises processing at least one data packet on a network.

3. The method of claim 2, wherein said processing said at least one data packet further comprises obtaining a signature data from said at least one data packet.

4. The method of claim 3, wherein said obtaining said signature data further comprises comparing said signature data to a database of stored signatures associated with said copyrighted material.

5. The method of claim 1, wherein said assessing further comprises obtaining copy license information from a user's client machine.

6. The method of claim 1, wherein said assessing further comprises obtaining a set of information about a receiving machine of said copying.

7. The method of claim 1, wherein said collecting said set of identity information further comprises implanting at least one software module for conducting said collecting.

8. The method of claim 1, wherein said collecting said set of identity information further comprises implanting at least one copyright identification data to identify said copyrighted material.

9. The method of claim 1, wherein said collecting said set of identity information further comprises collecting a set of billing information.

10. The method of claim 1, wherein said collecting said set of identity information further comprises triggering the execution of a previously installed computer program on a client machine.

11. The method of claim 1, wherein said collecting said set of identity information further comprises communicating said set of identity information to a data host.

12. The method of claim 1, wherein said invoicing further comprises using said set of identity information to prepare an invoice for said user involved in said copying.

13. The method of claim 1, wherein said invoicing further comprises communicating fee information to said user involved in said copying.

14. An apparatus for enforcing copyright, wherein said apparatus comprises:
means to monitor a copying of a copyrighted material;
means to assess whether a user involved in said copying possesses a right to copy said copyrighted material;
means to collect a set of identity information of said user; and
means to invoice said user.

15. The apparatus of claim 14, wherein said means to monitor further comprise means to process at least one data packet on a network.

16. The method of claim 15, wherein said means to process said at least one data packet further comprises means to obtain a signature data from said at least one data packet.

17. The apparatus of claim 16, wherein said means to obtain said signature data further comprises means to compare said signature data to a database of stored signatures associated with said copyrighted material.

18. The apparatus of claim 14, wherein said means to assess further comprises means to obtain copy license information from a user's client machine.

19. The apparatus of claim 14, wherein said means to assess further comprises means to obtain a set of information about a receiving machine of said copying.

20. The apparatus of claim 14, wherein said means to collect said set of identity information further comprises means to implant at least one software module.

21. The apparatus of claim 14, wherein said means to collect said set of identity information further comprises means to implant at least one copyright identification data to identify said copyrighted material.

22. The apparatus of claim 14, wherein said means to collect said set of identity information further comprises means to collect a set of billing information.

23. The apparatus of claim 14, wherein said means to collect said set of identity information further comprises means to trigger the execution of a previously installed computer program on a client machine.

24. The apparatus of claim 14, wherein said means to collect said set of identity information further comprises means to communicate said set of identity information to a data host.

25. The apparatus of claim 14, wherein said means to invoice further comprises means to prepare an invoice for said user involved in said copying using said set of identity information.

26. The apparatus of claim 14, wherein said means to invoice further comprises means to communicate fee information to said user involved in said copying.
